(19) United States
(12) Patent Application Publication
(10) Pub. No.: US 2007/0203266 A1
(43) Pub. Date: Aug. 30, 2007

(54) Synthetic cork compound

(76) Inventors: Jeannie Holmes, Weatherford, TX (US); Samuel W. Heath JR., Asheboro, NC (US)

Correspondence Address: PATTON BOGGS, L.L.P., 2001 ROSS AVENUE, SUITE 3000, DALLAS, TX, 75201, US

(21) Appl. No.: 11/598,553

(22) Filed: Nov. 13, 2006

Related U.S. Application Data
(63) Continuation-in-part of application No. 10/764,094, filed on Jan. 23, 2004.

(51) Int. Cl. C08L 97/02

(52) U.S. Cl. 524/13

(57) ABSTRACT

A synthetic cork compound includes a methyl vinyl silicone polymer with a microsphere agent such as soda lime borosilicate in an amount of approximately 5 to 50 weight percent. The microsphere agent gives the compound a low density. The methyl vinyl silicone polymer preferably includes polydimethylvinylsiloxane polymer from about 45 to 90 weight percent and fumed silica from about 5 to 50 weight percent. Preferably, the compound is catalyzed using chloro-platanic acid from about 0.1 to 5 percent. Additional components of the compound include toasted oak dust from about 0.1 to 25 weight percent, ground cork from about 5 to 50 weight percent, a pigment from about 0.1 to 5 weight percent, silicon hydride from about 0.1 to 25 weight percent, and ethynyl cyclohexanol from about 0.05 to 5 weight percent.

### CROSS-REFERENCE TO RELATED APPLICATIONS

This application is a continuation-in-part of U.S. patent application Ser. No. 10/764,094 filed on Jan. 23, 2004, which is hereby incorporated by reference.

### BACKGROUND OF THE INVENTION

1. Field of the Invention

This invention relates generally to synthetic cork compounds and in particular to a silicone-based compound that has the properties of natural cork, yet overcomes some of the disadvantages of natural cork.

2. Description of Related Art

Natural cork has been used for hundreds of years because of its unique properties and its natural availability. Cork comes from the bark of Quercus suber, the cork oak. The bark is regenerative, so careful attention is paid to removing the bark without damaging the underlying tree. Following removal, the bark is processed through a series of drying and boiling steps that typically take over 6 months to complete. After the final drying routine, the cork is cut into pieces to form whatever products are needed. The bark of a cork oak is only harvested once every 9 to 12 years, and a cork oak is usually over 40 years old before natural wine corks are produced from its bark.

Cork has many qualities that make it desirable, including its compressive properties. The high crush strength and elasticity of cork make the material ideal for sealing applications. Cork is often used in gaskets, and it is also used to seal bottles containing wine and other liquids.

Typically, dry cork has a specific gravity below one, which means that the material will float in water. This property has solidified the presence of cork in fisherman's tackle boxes, where cork is used as fishing bobbers to suspend fishing line at a selected level below the water's surface. Floating cork is also ideal as a buoy to mark a particular location in a body of water. Duck hunters use floating duck decoys made of cork to entice waterfowl within shooting distance.

Cork contains natural air voids that contribute to its low density. The presence of air in the cork makes the material suitable for sound and thermal insulation. Similarly, these voids and the compressive properties of cork make it a good vibration dampener.

Natural cork also has an attractive appearance. The indented, non-uniform surface of cork gives it a rugged, yet interesting look. Cork is often used in framed bulletin boards to allow businesses or individuals to attractively display notices, photographs, and other items. The high crush strength and elasticity of the material is ideal for attaching items to a bulletin board using thumb tacks or push pins.

Despite its attributes, natural cork has several drawbacks as well. Both environmental conditions and prolonged use can cause cork to dry out, crumble, and degrade. Because of variations in the compressibility of cork, precision manufacturing (i.e. sizing) of cork products can be difficult. These manufacturing concerns are compounded by the fact that cork sometimes shrinks over time.

Other problems associated with cork include the long growth cycle required before harvesting the cork. A single tree can only produce a harvestable crop once per decade. Additionally, the output and quality of a harvest can be affected by regional weather conditions during the growth cycle. Following the harvest, the cork must undergo a long processing time prior to final production of cork products.

Still another drawback of natural cork is that it sometimes houses a chemical called trichloroanisol (TCA). This chemical reacts with wine, and when a wine bottle is sealed with a cork containing TCA, the wine can adopt a musty taste and smell. Because of the problems caused by TCA-tainted corks, the wine industry refers to tainted wine as being “corked,” or suffering from cork taint.

Some of the attributes of cork have been replicated by synthetic materials. For example, hollow plastic moldings have been used to produce floating items, such as fishing bobbers, buoys, and duck decoys. Elastomers such as urethanes have been used as vibration and sound dampening materials. Fiber glass materials have been used as thermal insulators. While some of these materials may perform better than cork in certain applications, none of the materials incorporate all of cork's attributes.

Some wine makers now use synthetic stoppers to seal wine bottles. A heated debate has developed over the past few years regarding the use of natural cork versus synthetic bottle stoppers. Opponents of the synthetic alternatives extol the virtues of natural cork, saying that fine wine, especially well-aged wine, should only be sealed with natural cork. In support of their position, they claim that synthetic stoppers can affect the taste of wine, either by imparting a flavor to the wine, or by ineffectively sealing the bottle. However, natural cork's potential for tainting wine with TCA has made many wine connoisseurs wonder if cork alternatives would not be better for sealing wine products. In fact, in a survey conducted by Portuguese cork growers as recently as 2002, the support for natural cork as a wine bottle sealing material had dropped from 75% to 56% in only five months.

Some of the preferred attributes that wine connoisseurs associate with natural cork are its extraction characteristics and its physical appearance. In tests among consumer groups, participants seem to prefer a cork that is “moist and supple” and that is easily replaced in the bottle. Preferably, a cork is dimensionally sized to be tight enough to produce the traditional extraction sound when pulled, yet not so tight that it crumbles during extraction. Consumer groups also indicate a preference for the texture of cork as being its most important visual characteristic. Text or other indicia printed on the corks are also highly favored.

It is clear that a need exists for an easily manufacturable and inexpensive material that duplicates the positive attributes of natural cork, while eliminating some of the negative drawbacks of the material. More specifically, a synthetic material is needed that is elastically compressible and has a high crush strength and low density. The material should also have the appearance of natural cork with non-uniform surface voids, but should not crumble or promote growth of bacteria within the material. Finally, the material should provide excellent resistance to a wide range of environmental conditions and should preferably have a relatively low coefficient of friction to aid insertion and retraction in bottle sealing applications.

### BRIEF SUMMARY OF THE INVENTION

The present invention overcomes the drawbacks of natural cork, while incorporating the desired properties of the material. A synthetic cork compound is provided that includes a methyl vinyl silicone polymer and a microsphere agent. The compound includes polydimethylvinylsiloxane polymer from about 45 to 90 weight percent, silica from about 5 to 50 weight percent, soda lime borosilicate (i.e. the microsphere agent) from about 5 to 50 weight percent, oak dust from about 0.1 to 25 weight percent, ground cork from about 5 to 50 weight percent, a pigment from about 0.1 to 5 weight percent, and a cross-linking agent from about 0.1 to 5 weight percent. Preferably, the cross-linking agent is chloro-platanic acid. When this platinum catalyst is used, the compound may also contain high vinyl silicone polymer from about 0.5 to 10 weight percent, silicon hydride from about 0.1 to 25 weight percent, and ethynyl cyclohexanol from about 0.05 to 5 weight percent. If a curing agent such as peroxide is used in place of the platinum catalyst, it is not necessary to include the high vinyl silicone polymer, silicon hydride, and ethynyl cyclohexanol.

In another embodiment, the synthetic cork compound includes polydimethylvinylsiloxane polymer of about 57.2 weight percent, fumed silica of about 20.0 weight percent, soda lime borosilicate of about 5.0 weight percent, high vinyl silicone polymer of about 2.45 weight percent, oak dust of about 0.5 weight percent, ground cork of about 11.0 weight percent, zinc ferrite (i.e. pigment) of about 0.24 weight percent, chloro-platanic acid of about 1.25 weight percent, silicon hydride of about 2.2 weight percent, and ethynyl cyclohexanol of about 0.16 weight percent. Again, peroxide may be used in place of the platinum catalyst.

A stopper made from a synthetic cork compound is also provided according to an embodiment of the present invention. The synthetic cork compound includes polydimethylvinylsiloxane polymer from about 45 to 90 weight percent, fumed silica from about 5 to 50 weight percent, soda lime borosilicate (i.e. the microspheres) from about 5 to 50 weight percent, oak dust from about 0.1 to 25 weight percent, ground cork from about 5 to 50 weight percent, a pigment from about 0.1 to 5 weight percent, and a cross-linking agent from about 0.1 to 5 weight percent. Preferably, the cross-linking agent is chloro-platanic acid. When this platinum catalyst is used, the compound may also contain high vinyl silicone polymer from about 0.5 to 10 weight percent, silicon hydride from about 0.1 to 25 weight percent, and ethynyl cyclohexanol from about 0.05 to 5 weight percent. If a curing agent such as peroxide is used in place of the platinum catalyst, it is not necessary to include the high vinyl silicone polymer, silicon hydride, and ethynyl cyclohexanol. The stopper is used to seal bottles or containers holding wine or other substances.

Other objects, features, and advantages of the present invention will become apparent with reference to the drawings and detailed description that follow.

### BRIEF DESCRIPTION OF THE DRAWINGS

FIG. 1 depicts a front view of a wine bottle having a stopper made from the synthetic cork compound according to an embodiment of the present invention; and

FIG. 2 illustrates a perspective view of the stopper of FIG. 1.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, structural, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

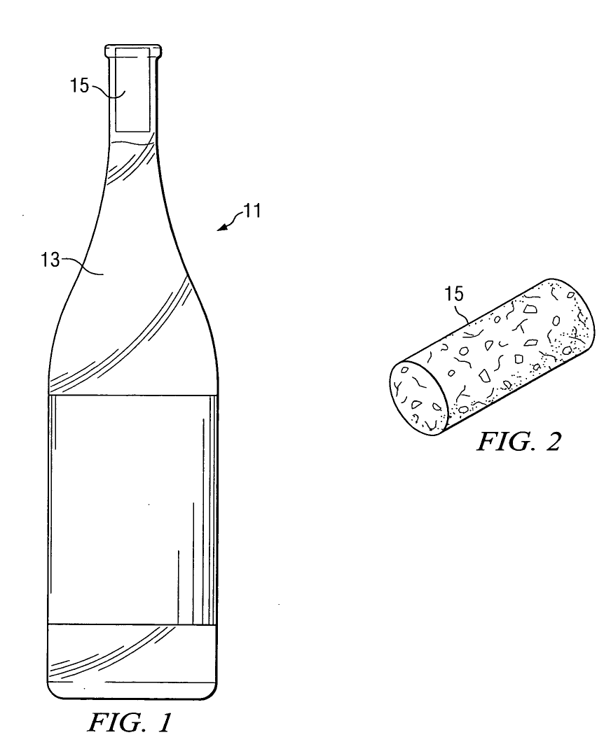

Referring to FIGS. 1-2, a wine bottle 11 for storing wine 13 is sealed by a stopper 15. Stopper 15 is made from a synthetic cork compound according to an embodiment of the present invention, and the stopper is illustrative of only one potential application of the synthetic cork compound. The compound is preferably made from a methyl vinyl silicone polymer. The following table illustrates ranges and preferred amounts for a synthetic cork composition according to an embodiment of the present invention:

TABLE 1

| | Preferred Amount | Range |
|---|---|---|
| Compound | (Weight %) | (Weight %) |
| Polydimethylvinylsiloxane Polymer | 40.7 | 20-60 |
| Fumed Silica | 27.1 | 20-60 |
| High Vinyl Silicone Polymer | 1.3 | 0.5-10 |
| Soda Lime Borosilicate (microsphere | 26.2 | 5-50 |
| agent) | | |
| Oak Dust | 1.0 | 0.1-25 |
| Zinc Ferrite (pigment) | 0.25 | 0.1-5 |
| Silicon Hydride | 2.3 | 0.1-25 |
| Chloro-platanic Acid (cross-linking | 0.99 | 0.1-5 |
| agent) | | |
| Ethynl Cyclohexanol (inhibitor) | 0.08 | 0.05-5 |

The synthetic cork compound includes a methyl vinyl silicone polymer, preferably polydimethylvinylsiloxane polymer, at an optimum range of about 20 to 60 weight percent and a fumed silica filler at an optimum range of about 20 to 60 weight percent. The preferred amounts for these components are about 40.7 and 27.1 weight percent, respectively. The fumed silica filler provides reinforcement for the compound. Although other fillers can be used with silicone polymers, fumed silica allows the compound to have a low specific gravity, which better simulates the properties of natural cork.

The compound includes soda lime borosilicate at an optimum range of about 5 to 50 weight percent, preferably about 26.2 weight percent. Soda lime borosilicate is a product having microspheres that encapsulate small amounts of air. Preferably, the addition of these microspheres to the methyl vinyl silicone polymer decreases the specific gravity of the resulting compound to less than 1.0, which makes the compound float in water. The microspheres are a key component in the synthetic cork compound, and they do not rupture when the compound is molded or extruded. Because of the low density they impart to the final compound, the microspheres are believed to give the compound many of the characteristic properties of natural cork. The novel composition of the present invention preferably has a specific gravity of about 0.5 to 1.0, and preferably 0.75.

Oak dust is included in the compound in an amount of about 0.1 to 25 weight percent, preferably 1.0 weight percent. “Oak dust” as referred to herein refers to the additive that is often used by wineries and wine makers during the wine-making process. Oak dust is added early in the wine making process, during fermentation, to preserve color and add complexity to the wine. Oak dust and other oak products such as cubes, dominoes, and blocks are used as alternatives to barrel aging to add oak flavor and tannins to bulk wine. Various types of oak may be used to make oak dust, but the most common oak dust is made from white oak trees grown in the United States, France, and several eastern European countries. Oak dust as referred to herein does not include dust made from Quercus suber, otherwise known as the cork oak. It is readily apparent to a person skilled in the art of wine making that ground, granulated, or pulverized cork would never be added to wine to aid in flavoring the wine. In fact, due to the potential harboring of TCA by natural cork, the addition of natural cork to a batch of wine may adversely effect the resulting flavor of the wine. As such, the definition of oak dust necessarily excludes cork dust or other products manufactured from natural cork.

When added to the silicone-based compound of the present invention, the oak dust gives the resulting product a mottled, speckled, or non-uniform appearance that closely resembles natural cork. The similarity in appearance of the compound taught and claimed herein to that of natural cork is due in large part to the addition of oak dust. Oak dust is similar in appearance to sawdust, and generally comes in one color. Although the oak dust used with the present composition is preferably toasted, untoasted oak dust could also be used to obtain similar results. Toasted oak dust can be purchased from World Cooperage located in Lebanon, Mo.

The synthetic cork compound includes a cross-linking agent to insure that the bonds of the compound form properly. The cross-linking agent may be a catalyst, such as platinum, or a curing agent such as peroxide. A platinum catalyst (i.e. chloro-platanic acid) is the preferred cross-linking agent for the compound and is included from about 0.1 to 5 weight percent, preferably 0.99 weight percent. Other catalysts, including but not limited to cesium, palladium, rhodium, iron, cobalt, nickel, rubidium, osmium, or iridium, could be used in place of platinum. However, these substances are generally not favored because they are either more expensive (e.g. palladium) or have problems associated with contamination (e.g. iron). Peroxide is not preferred as a cross-linking agent because it generally imparts an unpleasant odor to the cured compound, which could be transferred to wine or other liquids that come in contact with the synthetic cork compound.

If a catalyst such as chloro-platanic acid is used, the following components are also added to the compound: high vinyl silicone polymer from about 0.5 to 10 weight percent, silicon hydride from about 0.1 to 25 weight percent, and ethynyl cyclohexanol from about 0.05 to 5 weight percent. The preferred amounts of these components are about 1.3, 2.3, and 0.08 weight percent, respectively. Both silicon hydride and high vinyl silicone polymer are added to insure that the catalyzing reaction works properly. The vinyl component of high vinyl silicone polymer is preferably 8-20 percent pendant vinyl with a preferred amount of 14 percent. Ethynl cyclohexanol is an inhibitor that prevents premature curing of the synthetic cork compound at room temperature. A person of ordinary skill in the art will recognize that high vinyl silicone polymer, silicon hydride, and ethynyl cyclohexanol are not necessary if the synthetic cork compound is peroxide cured.

The synthetic cork compound preferably includes a zinc ferrite pigment from about 0.1 to 5 weight percent, preferably 0.25 weight percent. Zinc ferrite gives the finished product a color resembling that of natural cork. Of course, many different pigments could be used to vary the color of the synthetic cork compound, and the amount of pigment could also be varied to alter the color. While it is preferred that the compound closely approximate the color of natural cork, the color of the compound could vary, and the actual use of a pigment is optional.

A person of ordinary skill in the art will recognize that the components of the compound are mixed in a manner similar to that of other compounds. No extraordinary mixing procedures are required; however, for the compound to properly cure, it is best to mix the various components such that the cross-linking agent (e.g. chloro-platanic acid) is added last. This prevents premature curing of the compound. A preferred method for mixing the compound is discussed below in Example 1.

The synthetic cork compound is preferably either molded or extruded to form any one of many products. If molding is chosen, the material is preferably injection, compression, or transfer molded into the required shape, and then cured at a temperature between 250° F. and 400° F. for 0.5 to 6 minutes. For molding of a wine bottle stopper, a cylindrical steel mold is preheated to a minimum temperature of 300° F. If compression molding is chosen, the cork compound is placed in the cavity in a pre-weighed plug form. For transfer molding, a pre-weighed pad form is placed in the mold, while injection molding is accomplished by injecting a measured amount of the compound into the mold cavity or cavities. The steel mold is then clamped at a minimum pressure of 500 psi for a prescribed time based on the cure rate of the cork compound. The cure rate is determined by a moving die laboratory rheometer. The preferred curing temperature and time for compression molding a wine bottle stopper is 350° F. at 2.5 minutes.

When using a molding process, as opposed to an extrusion process, it is generally desired to double the amount of inhibitor (i.e. ethynyl cyclohexanol). If the preferred amounts referred to in Table 1 are used to form the compound for molding, it is preferable to use 0.16 weight percent of ethynyl cyclohexanol.

The preferred use of an extrusion process is explained in Example 1 below. Generally speaking, when the compound is extruded, the curing temperature is 400° F. to 600° F. for about 1 to 4 minutes. Preferably, the curing of the extruded compound takes place in a salt bath, but a person of ordinary skill in the art will recognize that while a salt bath may be the preferred medium for vulcanizing the compound, any continuous vulcanizing method could be used. Examples of other methods include the use of hot air, infrared, gamma, or microwave energy, which would all be focused in a continuous tunnel.

### EXAMPLE 1

A synthetic cork compound was formulated using a polydimethylvinylsiloxane polymer of about 40.7 weight percent and a fumed silica filler of about 27.1 weight percent. A high vinyl silicone polymer of about 1.3 weight percent was added to provide enough active sights for silicon hydride to react with the polymer during cross linking. Toasted oak dust of about 1.0 weight percent and a zinc ferrite pigment of about 0.25 weight percent were then blended with the silicone polymers and filler. Although many different pigments could be used, the zinc ferrite pigment helps simulate the appearance of natural cork. After blending in soda lime borosilicate of about 26.2 weight percent and ethynyl cyclohexanol of about 0.08 weight percent, silicon hydride of about 2.3 weight percent was added and blended. The final ingredient was chloro-platanic acid of about 0.99 weight percent. This component was added and blended well with the other components. The order of mixing the various ingredients of the compound was important to insure that the compound did not crosslink at room temperature. Mixing of the compound was accomplished with a low-shear sigma blade mixer such as a Baker Perkins mixer.

After the ingredients were thoroughly mixed, the mixture was extruded using a conventional rubber extruder having a feed throat that fed into a spiral screw. As the spiral screw received the mixture, the elastomer was softened and eventually forced through a die having an orifice. The die orifice formed the cross-sectional shape of the continuous mass of elastomer as it exited the extruder. In this example, the cross-section of the extruded material was round with a diameter of 22 mm so that the material could be formed into wine bottle stoppers.

After exiting the extruder, the continuous length of elastomer was passed to a curing station, in this case a continuous vulcanizer. The elastomer was drawn through the salt bath, which contained a sodium nitrate salt in liquid form at a temperature of 475° F. The viscosity of the salt at this temperature was similar to water. The extruded material was cured in the salt bath for approximately 2.5 minutes. As the extruded material exited the salt bath, the temperature of the material was in excess of 300° F. The material was passed through a water trough to cool the material below 200° F. One lot of material was then cut into lengths approximately 37 mm, while another lot was cut into lengths of approximately 43 mm to form two different sizes of stoppers for a wine bottle. The cutting step was performed by a conventional, automatic cutter. The final product was determined to have a specific gravity of 0.75.

The bottle stoppers (both the 37 mm and 43 mm lengths) produced by the exemplary method detailed above were tested to determine the ability of the compound to support the growth of TCA. A sample of 50 stoppers made from the synthetic cork compound were soaked in a 13% ethanol/water solution in a BATF (Bureau of Alcohol, Tobacco & Firearms) Certified Laboratory. Gas chromatography mass spectrometry was then performed to detect the presence of any 2,4,6 trichloroanisole. In two testing lots, less than 1 ng/L (1×10−9 grams per Liter) of TCA was detected. This amount is negligible in terms of its effect on the taste or quality of wine. Further qualitative analysis was performed by soaking two groups of eighteen corks in a 13% ethanol/water solution. Sensory evaluation of these corks revealed no moldy or taint-related defects.

Additional Testing

The same formulation as that made in Example 1 above was mixed to obtain a curable compound. Test slabs were molded in accordance with ASTM D3182. Tensile and elongation tests were performed in accordance with ASTM D412, and tear strength tests were performed according to ASTM D47 1. The results of these tests are shown in Table 2 for compounds having four different specific gravities.

TABLE 2

Specific Gravity

| | 0.6 | 0.75 | 0.8 | 0.9 |
|---|---|---|---|---|
| Durometer, pts | 57 | 62 | 66 | 70 |
| Tensile, psi | 752 | 725 | 676 | 792 |
| Elongation, % | 351 | 322 | 294 | 311 |
| Tear Die B, ppi | 135 | 145 | 140 | 140 |

Compression Stress Relaxation (CSR) testing according to either ISO 3384 or ASTM D3182 was performed to determine the ability of the compound to seal a container, such as a wine bottle. The tests were performed on samples obtained from an extruded synthetic cork stopper and a molded synthetic cork stopper. A curable compound was first obtained using the ingredients, amounts, and mixing procedure described in Example 1. After molding and extruding synthetic stoppers, a washer-shaped sample was cut from each stopper, and each washer was placed in a CSR test fixture manufactured by JAMAK Fabrication, Inc. Each test fixture was then placed in a Comten Deflection apparatus, and each sample was compressed to 25% of its original thickness. A small electric current was passed through the test fixture such that current flowed between the upper and lower halves of the test fixture. A battery test light was used to indicate the flow of current. The load on each washer was slowly decreased until the battery test light turned off, indicating that the upper and lower halves of the test fixture had separated. The load on the washer was immediately determined and recorded at the time the battery test light turned off.

The test sequence for each washer was such that an initial load amount was recorded, and then subsequent load amounts were measured at 48 hours and 144 hours. The results of the tests are shown in Table 3 in comparison with test results for natural cork. The sealing forces are illustrated in the table as a percentage of the initial sealing force measured for a particular sample.

TABLE 3

| | Initial | Retained | Retained |
|---|---|---|---|
| | Sealing | After | After |
| Sample Type | Force (%) | 48 Hours | 144 Hours |
| Synthetic Molded Stoppers | 100 | 92.8 | 93.2 |
| Synthetic Extruded Stoppers | 100 | 83.0 | 79.6 |
| Natural Cork Stoppers | 100 | 81.5 | 74.9 |

Initial testing on insertion force was conducted at a wine bottling facility using synthetic wine bottle stoppers manufactured according to the ingredients, amounts, and procedures described in Example 1. The results of the initial testing indicate that the forces required to insert and remove a synthetic cork wine bottle stopper from a wine bottle is substantially the same as the forces required when using a stopper made from natural cork.

A synthetic cork compound according to another embodiment of the present invention also includes a silicone polymer. The following table illustrates ranges and preferred amounts for the synthetic cork composition:

TABLE 4

| | Preferred Amount | Range |
|---|---|---|
| Compound | (Weight %) | (Weight %) |
| Polydimethylvinylsiloxane Polymer | 57.2 | 45-90 |
| Silica | 20.0 | 5-50 |
| High Vinyl Silicone Polymer | 2.45 | 0.5-10 |
| Soda Lime Borosilicate (microsphere | 5.0 | 5-50 |
| agent) | | |
| Oak Dust | 0.5 | 0.1-25 |
| Ground Cork | 11.0 | 5-50 |
| Zinc Ferrite (pigment) | 0.24 | 0.1-5 |
| Silicon Hydride | 2.2 | 0.1-25 |
| Chloro-platanic Acid (cross-linking | 1.25 | 0.1-5 |
| agent) | | |
| Ethynl Cyclohexanol (inhibitor) | 0.16 | 0.05-5 |

The synthetic cork compound includes a silicone polymer, preferably polydimethylvinylsiloxane polymer, at an optimum range of about 45 to 90 weight percent and a silica filler, preferably fumed silica, at an optimum range of about 5 to 50 weight percent. The preferred amounts for these components are about 57.2 and 20.0 weight percent, respectively. The fumed silica filler provides reinforcement for the compound. Although other fillers can be used with silicone polymers, fumed silica allows the compound to have a low specific gravity, which better simulates the properties of natural cork.

The compound includes a microsphere agent, preferably an inorganic microsphere agent such as soda lime borosilicate, at an optimum range of about 5 to 50 weight percent, preferably about 5.0 weight percent. Soda lime borosilicate is a product having microspheres that encapsulate small amounts of air. Preferably, the addition of these microspheres to the methyl vinyl silicone polymer decreases the specific gravity of the resulting compound to less than 1.0, which makes the compound float in water. The microspheres are a key component in the synthetic cork compound, and they do not rupture when the compound is molded or extruded. Because of the low density they impart to the final compound, the microspheres are believed to give the compound many of the characteristic properties of natural cork. The novel composition of the present invention preferably has a specific gravity of about 0.5 to 1.0, and preferably 0.75.

Oak dust is included in the compound in an amount of about 0.1 to 25 weight percent, preferably 0.5 weight percent. “Oak dust” as referred to herein refers to the additive that is often used by wineries and wine makers during the wine-making process. Oak dust is added early in the wine making process, during fermentation, to preserve color and add complexity to the wine. Oak dust and other oak products such as cubes, dominoes, and blocks are used as alternatives to barrel aging to add oak flavor and tannins to bulk wine. Various types of oak may be used to make oak dust, but the most common oak dust is made from white oak trees grown in the United States, France, and several eastern European countries. Oak dust as referred to herein does not include dust made from Quercus suber, otherwise known as the cork oak. It is readily apparent to a person skilled in the art of wine making that ground, granulated, or pulverized cork would never be added to wine to aid in flavoring the wine. In fact, due to the potential harboring of TCA by natural cork, the addition of natural cork to a batch of wine may adversely effect the resulting flavor of the wine. As such, the definition of oak dust necessarily excludes cork dust or other products manufactured from natural cork.

When added to the silicone-based compound of the present invention, the oak dust gives the resulting product a mottled, speckled, or non-uniform appearance that closely resembles natural cork. The similarity in appearance of the compound taught and claimed herein to that of natural cork is due in large part to the addition of oak dust. Oak dust is similar in appearance to sawdust, and generally comes in one color. Although the oak dust used with the present composition is preferably toasted, untoasted oak dust could also be used to obtain similar results. Toasted oak dust can be purchased from World Cooperage located in Lebanon, Mo.

Ground cork having a preferred particle size of about 30 to 80 microns is included in the compound in an amount of about 5 to 50 weight percent, preferably about 11.0 weight percent. Like oak dust, ground cork enhances the appearance of the compound to more closely resemble that of natural cork. The cork particles, which preferably are about 30 to 80 microns in size, overcome some of the tearing problems experienced during insertion of bottle stoppers made from silicone-based compounds not having ground cork. Despite the addition of natural cork to the compound, the inert characteristics of the compound are maintained. When used to form bottle stoppers for sealing wine bottles, the compound with these amounts of ground cork does not have the tendency to harbor TCA like a stopper made entirely from natural cork. Ground cork may be obtained from Maryland Cork of Elkton, Md.

The synthetic cork compound includes a cross-linking agent to insure that the bonds of the compound form properly. The cross-linking agent may be a catalyst, such as platinum, or a curing agent such as peroxide. A platinum catalyst (i.e. chloro-platanic acid) is the preferred cross-linking agent for the compound and is included from about 0.1 to 5 weight percent, preferably 1.25 weight percent. Other catalysts, including but not limited to cesium, palladium, rhodium, iron, cobalt, nickel, rubidium, osmium, or iridium, could be used in place of platinum. However, these substances are generally not favored because they are either more expensive (e.g. palladium) or have problems associated with contamination (e.g. iron). Peroxide is not preferred as a cross-linking agent because it generally imparts an unpleasant odor to the cured compound, which could be transferred to wine or other liquids that come in contact with the synthetic cork compound.

If a catalyst such as chloro-platanic acid is used, the following components are also added to the compound: high vinyl silicone polymer from about 0.5 to 10 weight percent, silicon hydride from about 0.1 to 25 weight percent, and ethynyl cyclohexanol from about 0.05 to 5 weight percent. The preferred amounts of these components are about 2.45, 2.2, and 0.16 weight percent, respectively. Both silicon hydride and high vinyl silicone polymer are added to insure that the catalyzing reaction works properly. The vinyl component of high vinyl silicone polymer is preferably 8-20 percent pendant vinyl with a preferred amount of 14 percent. Ethynl cyclohexanol is an inhibitor that prevents premature curing of the synthetic cork compound at room temperature. A person of ordinary skill in the art will recognize that high vinyl silicone polymer, silicon hydride, and ethynyl cyclohexanol are not necessary if the synthetic cork compound is peroxide cured.

The synthetic cork compound preferably includes a zinc ferrite pigment from about 0.1 to 5 weight percent, preferably 0.24 weight percent. Zinc ferrite gives the finished product a color resembling that of natural cork. Of course, many different pigments could be used to vary the color of the synthetic cork compound, and the amount of pigment could also be varied to alter the color. While it is preferred that the compound closely approximate the color of natural cork, the color of the compound could vary, and the actual use of a pigment is optional.

A person of ordinary skill in the art will recognize that the components of the compound are mixed in a manner similar to that of other compounds. No extraordinary mixing procedures are required; however, for the compound to properly cure, it is best to mix the various components such that the cross-linking agent (e.g. chloro-platanic acid) is added last. This prevents premature curing of the compound.

The synthetic cork compound is preferably either molded or extruded to form any one of many products. If molding is chosen, the material is preferably injection, compression, or transfer molded into the required shape, and then cured at a temperature between 250° F. and 400° F. for 0.5 to 6 minutes. For molding of a wine bottle stopper, a cylindrical steel mold is preheated to a minimum temperature of 300° F. If compression molding is chosen, the cork compound is placed in the cavity in a pre-weighed plug form. For transfer molding, a pre-weighed pad form is placed in the mold, while injection molding is accomplished by injecting a measured amount of the compound into the mold cavity or cavities. The steel mold is then clamped at a minimum pressure of 500 psi for a prescribed time based on the cure rate of the cork compound. The cure rate is determined by a moving die laboratory rheometer. The preferred curing temperature and time for compression molding a wine bottle stopper is 350° F. at 2.5 minutes.

The synthetic cork compounds described herein may be formed into many different products. Since the compounds replicate many of the advantageous properties of natural cork, the compounds may be easily substituted for natural cork. Some of the applications for the synthetic cork compounds include, but are not limited to, wine bottle stoppers (or sealers); shoe heels; sound and thermal insulation; car exhaust systems and other dampening applications (sound, vibration, and heat); core material for composite laminates in the automobile and aviation industries; fly rods and other fishing poles having cork handles; fishing bobbers; pegboard and bulletin board sheets; flooring and sub-flooring for houses and other buildings, adhesive backed tape; and grip material for bicycles, bats, and tennis rackets. A person of ordinary skill in the art will recognize that, in addition to these applications, the compounds may be used in any application or product that is well suited for natural cork.

The primary advantages of the present invention are related to the compounds' replication of the favorable properties of natural cork. The compounds have a low specific gravity, which makes them float in water similar to cork. When subjected to compressive forces, the compounds behave like natural cork due to their similar elastic compressibility and high crush strength. These compressive properties make the compounds well suited for sealing applications and applications such as bulletin boards in which thumb tacks are pushed into the material. The synthetic cork compounds also have an appearance that is remarkably similar to cork, both in color and texture. This is a very important property, since acceptance of the compounds as a substitute for natural cork will likely be more prevalent if products made from the compounds resemble real cork.

While the most desirable attributes of natural cork are replicated, the compounds do not exhibit the less desirable traits of cork. The compounds are much easier to manufacture since they do not have the dimensional stability or shrinkage problems associated with natural cork. The problems associated with growing, harvesting, and processing natural cork are reduced or eliminated. Because the compounds can be quickly mixed and do not require long cure times, the total production time for a given product is relatively minimal. Additionally, the silicone-based compounds have a very high resistance to temperature and ultraviolet radiation. This resistance makes the compounds much better than natural cork in resisting degradation caused by adverse environmental conditions.

As previously noted, the compounds described herein are ideally suited for replacing natural cork stoppers in wine bottles. With respect to this application, the compounds present several advantages. First, and perhaps most important, is that the compounds are inert, and even with the addition of small amounts of natural cork in the compounds, the compounds do not promote the growth of TCA. Unlike natural cork, bottle stoppers made from the novel compounds of the present invention will not taint wine by introducing TCA to the wine.

Another advantage is that the compounds' compressive and sealing properties are similar to or better than natural cork, which means that a stopper made from any of the compounds will effectively seal a wine bottle. The compounds are not susceptible to crumbling or drying out like natural cork. This is especially helpful when only a portion of the wine is drunk from a bottle, and the stopper must be used to re-seal the bottle. Because the compounds are silicone based, bottle stoppers made from the compounds exhibit excellent extraction characteristics. Unlike most synthetic stoppers or natural cork stoppers, which are sometimes coated with silicone for lubrication, stoppers made from the novel compounds described herein are silicone-based and therefore have “built-in” lubrication.

As mentioned previously, some of the resistance to synthetic stoppers by wine connoisseurs has been based on the stoppers not replicating the appearance and feel of natural cork. The compounds according to the principles of the present invention overcome this drawback. The microspheres create a very lightweight material that feels like natural cork. The inclusion of oak dust and zinc ferrite (and in some cases ground cork) cause the compounds to very closely resemble the mottled, non-uniform appearance of natural cork. This advantage is extremely important since it will likely encourage widespread acceptance of a synthetic material for sealing wine bottles.

It should be apparent from the foregoing that an invention having significant advantages has been provided. While the invention is shown in only a few of its forms, it is not just limited but is susceptible to various changes and modifications without departing from the spirit thereof.

We claim:

1. A synthetic cork compound comprising:
a methyl vinyl silicone polymer from about 45 to 90 weight percent;
a silica filler from about 5 to 50 weight percent;
a microsphere agent from about 5 to 50 weight percent;
a cross-linking agent from about 0.1 to 5 weight percent;
oak dust from about 0.1 to 25 weight percent; and
ground cork from about 5 to 50 weight percent.

2. The synthetic cork compound according to claim 1, wherein the methyl vinyl silicone polymer is polydimethylvinylsiloxane.

3. The synthetic cork compound according to claim 1, wherein the oak dust is toasted oak dust.

4. The synthetic cork compound according to claim 1, wherein the particle sizes of the ground cork are from about 30 to 80 microns.

5. The synthetic cork compound according to claim 1, wherein the microsphere agent is soda lime borosilicate.

6. The synthetic cork compound according to claim 1, wherein the cross-linking agent is chloro-platanic acid.

7. The synthetic cork compound according to claim 1, wherein the cross-linking agent is peroxide.

8. The synthetic cork compound according to claim 1 further comprising:
a high vinyl silicone polymer from about 0.5 to 10 weight percent;
pigment from about 0.1 to 5 weight percent;
silicon hydride from about 0.1 to 25 weight percent;
ethynyl cyclohexanol from about 0.05 to 5 weight percent; and
wherein the cross-linking agent is chloro-platanic acid.

9. The synthetic cork compound according to claim 9, wherein:
the methyl vinyl silicone polymer is polydimethylvinylsiloxane; and
the microsphere agent is soda lime borosilicate.

10. A synthetic cork compound comprising:
a methyl vinyl silicone polymer of about 57.2 weight percent;
a fumed silica filler of about 20.0 weight percent;
a microsphere agent of about 5.0 weight percent;
a cross-linking agent of about 1.25 weight percent;
oak dust of about 0.5 weight percent; and
ground cork of about 11.0 weight percent.

11. The synthetic cork compound according to claim 10, wherein the methyl vinyl silicone polymer is polydimethylvinylsiloxane.

12. The synthetic cork compound according to claim 10, wherein the oak dust is toasted oak dust.

13. The synthetic cork compound according to claim 10, wherein the particle sizes of the ground cork are from about 30 to 80 microns.

14. The synthetic cork compound according to claim 10, wherein the microsphere agent is soda lime borosilicate.

15. The synthetic cork compound according to claim 10, wherein the cross-linking agent is chloro-platanic acid.

16. The synthetic cork compound according to claim 10, wherein the cross-linking agent is peroxide.

17. The synthetic cork compound according to claim 10 further comprising:
a high vinyl silicone polymer of about 2.45 weight percent;
pigment of about 0.24 weight percent;
silicon hydride of about 2.2 weight percent;
ethynyl cyclohexanol of about 0.16 weight percent; and
wherein the cross-linking agent is chloro-platanic acid.

18. The synthetic cork compound according to claim 10, wherein:
the methyl vinyl silicone polymer is polydimethylvinylsiloxane; and
the microsphere agent is soda lime borosilicate.

19. A bottle stopper formed from a synthetic cork compound comprising:
a methyl vinyl silicone polymer from about 45 to 90 weight percent;
a silica filler from about 5 to 50 weight percent;
a microsphere agent from about 5 to 50 weight percent;
a cross-linking agent from about 0.1 to 5 weight percent;
oak dust from about 0.1 to 25 weight percent; and
ground cork from about 5 to 50 weight percent.

20. The stopper according to claim 19, wherein the methyl vinyl silicone polymer is polydimethylvinylsiloxane.

21. The synthetic cork compound according to claim 19, wherein the oak dust is toasted oak dust.

22. The synthetic cork compound according to claim 19, wherein the particle sizes of the ground cork are from about 30 to 80 microns.

23. The stopper according to claim 19, wherein the microsphere agent is soda lime borosilicate.

24. The stopper according to claim 19, wherein the cross-linking agent is chloro-platanic acid.

25. The stopper according to claim 19, wherein the cross-linking agent is peroxide.

26. The stopper according to claim 19 further comprising:
a high vinyl silicone polymer from about 0.5 to 10 weight percent;
pigment from about 0.1 to 5 weight percent;
silicon hydride from about 0.1 to 25 weight percent;
ethynyl cyclohexanol from about 0.05 to 5 weight percent; and
wherein the cross-linking agent is chloro-platanic acid.

27. A synthetic cork compound according to claim 19 further comprising:
a high vinyl silicone polymer of about 2.45 weight percent;
pigment of about 0.24 weight percent;
silicon hydride of about 2.2 weight percent;
ethynyl cyclohexanol of about 0.16 weight percent;
wherein the cross-linking agent is chloro-platanic acid present in an amount of about 1.25 weight percent;
wherein the methyl vinyl silicone polymer is polydimethylvinylsiloxane present in an amount of about 57.2 weight percent;
wherein the fumed silica filler is present in an amount of about 20.0 weight percent; and
wherein the microsphere agent is soda lime borosilicate present in an amount of about 5.0 weight percent.
